(19) United States
(12) Patent Application Publication
(10) Pub. No.: US 2026/0062533 A1
(43) Pub. Date: Mar. 5, 2026

(54) POLYMER RECYCLATE PROCESSES AND PRODUCTS

(71) Applicant: Equistar Chemicals, LP, Houston, TX (US)

(72) Inventors: Harilaos Mavridis, Lebanon, OH (US); Lindsay E. Corcoran, Liberty Township, OH (US)

(73) Assignee: Equistar Chemicals, LP, Houston, TX (US)

(21) Appl. No.: 19/313,008

(22) Filed: Aug. 28, 2025

Related U.S. Application Data
(60) Provisional application No. 63/688,387, filed on Aug. 29, 2024.

(51) Int. Cl. C08J 11/12

(52) U.S. Cl. CPC C08J 11/12

(57) ABSTRACT

A method for processing a polyolefin recyclate comprises adding the polyolefin recyclate to a reaction zone and implementing visbreaking conditions in the reaction zone to produce a treated polymer melt. The visbreaking conditions comprise adding specific energy to the polyolefin recyclate sufficient to initiate visbreaking but insufficient to initiate degradation of the polyolefin recyclate and reducing pressure on at least a portion of the reaction zone to less than atmospheric pressure to produce a treated polymer melt and an off-gas byproduct stream. The polyolefin recyclate has a first melt index (MI₁), the treated polymer melt has a second melt index (MI₂), and MI₂/MI₁ is greater than or equal to 3.

### PRIOR RELATED APPLICATIONS

This application claims the benefit of priority to U.S. Provisional Application No. 63/688,387, filed on Aug. 29, 2024, which is incorporated here by reference in its entirety.

### FIELD OF THE INVENTION

This invention relates to the use of visbreaking processes to improve the processing characteristics of polyolefin recyclates. The invention further relates to compositions produced by such processes.

### BACKGROUND OF THE INVENTION

Polyolefins, in particular polyethylene and polypropylene, are increasingly consumed in large amounts for many applications, including packaging for food and other goods, fibers, automotive components, and a great variety of manufactured articles. However, this massive use of polyolefins is creating a concern as regarding the potential environmental impact of the waste materials generated after the first use. In fact, large amounts of waste plastic materials are presently coming from differential recovery of municipal plastic wastes, mainly constituted of flexible packaging (cast film, blown film and BOPP film), rigid packaging, blow molded and injection molded bottles or containers, or a mixture thereof. Usually, through a step of separation from other polymers, such as PVC, PET or PS, two main polyolefinic fractions are obtained, namely polyethylenes (in particular HDPE, LDPE, LLDPE) and polypropylenes (homopolymers, random copolymers, heterophasic copolymers).

However, limited efficiency of separation processes results in a target polyolefin recyclate grade containing contaminants. For instance, a HDPE recyclate may contain some amount of polyolefins other than HDPE, some amount of hetero-containing polymer, some amount of NIAS, or a mixture thereof. The multicomponent nature of the recycled polyolefins often results in poor mechanical and optical performance of articles prepared from polyolefin recyclates or blends of polyolefin recyclates with virgin polymers. Moreover, the molecular weight and/or molecular weight distribution of the recycled polyolefins can limit the range of virgin polymers into which recycled polyolefins can be incorporated.

There is accordingly a need to overcome the disadvantages of the prior art and to provide processes to produce polyolefin compositions comprising recycled polyolefins, such polyolefin compositions having a useful combination of mechanical properties. Ideally, such processes would be highly flexible and could be implemented with commonly used equipment and familiar techniques to produce a wide variety of products.

### SUMMARY OF THE INVENTION

In general, the present disclosure relates to methods for processing polyolefin recyclates, including but not limited to polyethylene and/or polypropylene. A method for processing polyolefin recyclate comprises adding a polyolefin recyclate to a reaction zone. An amount of specific energy is added to the polyolefin recyclate in the form of mechanical shearing to produce a first treated polymer recyclate. Pressure is reduced on at least a portion of the reaction zone to less than atmospheric pressure. A second treated polymer recyclate and an off-gas byproduct stream are then withdrawn from the reaction zone. The polyolefin recyclate has a first melt index (MI₁). The second treated polymer recyclate has a second melt index (MI₂). MI₂/MI₁ is greater than or equal to 3, greater than or equal to 10, greater than or equal to 15, greater than or equal to 20, or greater than or equal to 25. In further embodiments, the second treated polymer recyclate is pelletized to produce a treated polymer recyclate product. In some embodiments, MI₂/MI₁ is less than or equal 100 or less than or equal to 75.

In some embodiments of the method, the first melt index is an I₂ (ASTM D-1238, 2.16 kg, 190° C.) in the range of from 0.2 dg/min. to 2.5 dg/min. In some embodiments of the method, the second treated polymer recyclate has an I₂ (ASTM D-1238, 2.16 kg, 190° C.) greater than or equal to 2 dg/min., greater than or equal to 10 dg/min., greater than or equal to 10 dg/min., greater than or equal to 20 dg/min., greater than or equal to 25 dg/min., greater than or equal to 30 dg/min., or greater than or equal to 35 dg/min.

In some embodiments of the method, the first melt index is an I₂₁ (ASTM D-1238, 21.6 kg, 190° C.) in the range of from 5 dg/min. to 70 dg/min. In some embodiments of the method, the second treated polymer recyclate has an I₂₁ (ASTM D-1238, 21.6 kg, 190° C.) greater than or equal to 200 dg/min., greater than or equal to 300 dg/min., greater than or equal to 400 dg/min., greater than or equal to 700 dg/min., greater than or equal to 750 dg/min., greater than or equal to 800 dg/min., or greater than or equal to 900 dg/min.

In some embodiments of the method, the polyolefin recyclate has an 12 (ASTM D-1238, 2.16 kg, 190° C.) in the range of from 0.2 dg/min. to 2.5 dg/min. and an I₂₁ (ASTM D-1238, 21.6 kg, 190° C.) in the range of from 5 dg/min. to 70 dg/min. In some embodiments of the method, the second treated polymer recyclate has an I₂ (ASTM D-1238, 2.16 kg, 190° C.) greater than or equal to 2 dg/min., greater than or equal to 10 dg/min., greater than or equal to 10 dg/min., greater than or equal to 20 dg/min., greater than or equal to 25 dg/min., greater than or equal to 30 dg/min., or greater than or equal to 35 dg/min., and an 121 (ASTM D-1238, 21.6 kg, 190° C.) greater than or equal to 200 dg/min., greater than or equal to 300 dg/min., greater than or equal to 400 dg/min., greater than or equal to 700 dg/min., greater than or equal to 750 dg/min., greater than or equal to 800 dg/min., or greater than or equal to 900 dg/min.

In some embodiments of the method, the pressure is reduced to a pressure in the range of from 7.6 mm Hg absolute to 684 mm Hg absolute, from 22.8 mm Hg absolute to 532 mm Hg absolute, or from 38 mm Hg absolute to 380 mm Hg absolute, or less than or equal to 304 mm Hg absolute, less than or equal to 228 mm Hg absolute, less than or equal to 152 mm Hg absolute, or less than or equal to 76 mm Hg absolute.

In some embodiments, the polyolefin recyclate comprises a polyethylene, a polypropylene, or a combination thereof.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other compositions and/or processes for carrying out the same purposes of the present invention. It should also be realized by those skilled in the art that such equivalent compositions and/or processes do not depart from the spirit and scope of the invention as set forth in the appended claims. The novel features which are believed to be characteristic of the invention, both as to its properties and/or method of manufacture, together with further objects and advantages will be better understood from the following description.

### BRIEF DESCRIPTION OF THE FIGURES

The claimed subject matter may be understood by reference to the following description taken in conjunction with the accompanying drawings, in which like reference numerals identify like elements, and in which:

FIG. 1 is a graphical representation showing the increase in melt index by subjecting an HDPE recyclate to visbreaking conditions without vacuum;

FIG. 2 is a graphical representation showing the increase in melt index by subjecting an HDPE recyclate to visbreaking conditions with and without vacuum;

FIG. 3 is a graphical representation showing the increase in melt index by subjecting a LLDPE recyclate to visbreaking conditions with and without vacuum;

FIG. 4 is a graphical representation showing the increase in melt index by subjecting a LLDPE recyclate to visbreaking conditions with and without vacuum; and

FIG. 5 is a graphical representation showing the increase in melt index by subjecting a LDPE recyclate to visbreaking conditions with and without vacuum.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

As used herein, “antioxidant agents” means compounds that inhibit oxidation, a chemical reaction that can produce free radicals and chain reactions that may damage the cells of organisms. Antioxidants are differentiated based on their reaction mechanisms and include: (1) primary antioxidants, (2) secondary antioxidants, and (3) multifunctional antioxidants.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used herein, “consisting essentially of” excludes additional material elements, but allows the inclusions of non-material elements that do not substantially change the nature of the invention.

As used herein, “consisting of” is closed and excludes all additional elements.

As used herein, “conversion” is used to denote the percentage of a component fed which disappears across a reactor.

As used herein, “melting conditions” means temperature, pressure, and shear force conditions implemented in an extruder sufficient to produce a polymer melt form a feed of polymer pellets or powder.

As used herein, “multifunctional antioxidants” means antioxidants that can exhibit both primary and secondary antioxidant properties. Secondary antioxidants are particularly useful in synergistic combinations with primary antioxidants. Blends of stabilizers with different mechanisms are state-of-the-art today. Phosphites are most effective during processing and protect both the polymer and the primary antioxidant. Hydrolytically stable phosphites are the most frequently used processing stabilizers in high-performance additive systems. Thioethers are useful only in increasing the long-term thermal stability in conjunction with phenolic antioxidants. The use of thioethers is limited to areas where their possible effect on odor or taste and their negative interaction with hindered amine light stabilizers is not important.

As used herein, “polyolefin recyclate” means post-consumer recycled (“PCR”) polyolefin and/or post-industrial recycled (“PIR”) polyolefin. Polyolefin recyclate is derived from an end product that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs, including flexible packaging (cast film, blown film and BOPP film), rigid packaging, blow molded bottles, and injection molded containers. Usually, through a step of separation from other polymers, such as PVC, PET or PS, two main polyolefinic fractions are obtained, namely polyethylene recyclate (including HDPE, MDPE, LDPE, and LLDPE) and polypropylene recyclate (including homopolymers, random copolymers, and heterophasic copolymers). Polyethylene recyclate can be further separated to recover a portion having HDPE as the primary constituent. In addition to contamination from dissimilar polyolefins, HDPE recyclate frequently contains other impurities such as PMMA, PC, wood, paper, textile, cellulose, food, and other organic wastes, many of which cause the HDPE recyclate to have an unpleasant odor before and after typical processing.

As used herein, “primary antioxidants” means compounds which function essentially as free radical terminators or scavengers. Primary antioxidants react rapidly with peroxy and alkoxy radicals. The majority of primary antioxidants for polymers are sterically hindered phenols.

As used herein, “reaction zone” refers to a portion of an extruder or other mixing apparatus wherein visbreaking conditions are implemented on feed comprising a polyolefin recyclate. In some embodiments, a single extruder or other mixing apparatus can contain a plurality of reaction zones. The pressure is reduced to less than atmospheric pressure in at least a portion of the reaction zone.

As used herein, “residence time,” in the context of visbreaking, means the cumulative amount of time during which a polyolefin recyclate is subjected to visbreaking conditions. As soon as the melted polyolefin recyclate enters the reaction zone, conversion of the polymer melt from polyolefin recyclate to a treated polymer melt begins. It should be understood that the residence time is measured from the time the polymer melt enters the reaction zone until the treated polymer melt exits the reaction zone. If there is more than one reaction zone, the residence time is the cumulative time of the time the polymer melt spends in each reaction zone.

As used herein, “secondary antioxidants” means compounds which are preventive antioxidants that function by retarding chain initiation. Secondary antioxidants react with hydroperoxides to yield non-radical products and are, therefore, frequently called hydroperoxide decomposers.

As used herein, “untreated polyolefin recyclate” means polyolefin recyclate after collection and sorting but prior to being subjected to the process disclosed herein.

As used herein, “virgin polymers” are pre-consumer polyolefins. Pre-consumer polyolefins are polyolefin products obtained directly or indirectly from petrochemical feedstocks fed to a polymerization apparatus. Pre-consumer polyolefins can be subjected to post polymerization processes such as, but not limited to, extrusion, pelletization, visbreaking, and/or other processing completed before the product reaches the end-use consumer. Virgin polymers include virgin polyethylene and virgin polypropylene.

As used herein, “visbreaking” means treating a polymer thermally and/or chemically to produce a reduction in Mn, Mw, and MWD, and an increase in MI (or MFR for PP) and HLMI of the polymer so treated. Applying high temperatures and/or adding radical source such as peroxides to polyolefinic materials results in degradation of the polymer chains and reduction of the average molecular weight of the polymer. In parallel, the molecular weight distribution gets narrower. When intentionally performing such methods for modifying the properties of polymers, these practices are commonly called “visbreaking.” Especially for polypropylenes, adding peroxides is a standard practice to adjust the melt flow rate and narrow the molecular weight distribution. The polypropylenes obtained in this way are also frequently designated as controlled rheology polypropylenes.

### Treating a Polyolefin Recyclate

A method for processing a polyolefin recyclate is disclosed. It has been surprisingly discovered that applying a vacuum to a reaction zone in which visbreaking conditions are being implemented can enhance the results achieved by visbreaking. That is to say, in a visbreaking process that increases the melt index of a polyolefin recyclate, it has been discovered that applying a vacuum to the visbreaking process can achieve an even greater increase in the melt index.

### Polyolefin Recyclate

In some embodiments, the polyolefin recyclate comprises a polyethylene, a polypropylene, or a combination thereof.

In some embodiments, the polyethylene comprises a high-density polyethylene (HDPE), a medium density polyethylene (MDPE), a low-density polyethylene (LDPE), a linear low-density polyethylene (LLDPE), or a combination thereof.

Suitable polyethylenes for use as polyethylene recyclate include ethylene homopolymers and copolymers of units derived from ethylene and units derived from one or more of C₃-C₈ α-olefins or mixtures thereof. In some embodiments, the units derived from the one or more C₃-C₈ α-olefin comonomers are present in amounts up to 15 wt. %, based upon the total weight of the copolymer of ethylene. The ethylene homopolymers and copolymers can be produced using either Ziegler Natta or single-site catalysts, e.g., metallocene catalysts. The ethylene homopolymers and copolymers can be produced using a gas phase process, high pressure process, slurry process, or solution process. Ethylene homopolymers and ethylene-C₃-C₈ α-olefin copolymers include very low-density polyethylene (“VLDPE”), low-density polyethylene (“LDPE”), linear low-density polyethylene (“LLDPE”), medium density polyethylene (“MDPE”) and high-density polyethylene (“HDPE”). VLDPE is defined as having a density of 0.860 to 0.910 g/cm³, as measured by ASTM D-1505 “Column Method.” LDPE and LLDPE are defined as having densities in the range of from 0.910 to 0.930 g/cm³. MDPE is defined as having a density of 0.930 to 0.945 g/cm³. HDPE is defined as having a density of at least 0.945 g/cm³, or from 0.945 to 0.969 g/cm³. In some embodiments, the ethylene homopolymers and copolymers have melt indexes (“MIs”), as measured by ASTM D 1238, condition 190° C./2.16 kg, from 0.01 to 400 dg/min, from 0.1 to 200 dg/min., or from 1 to 100 dg/min.

In some embodiments, the polypropylene comprises a propylene homopolymer, a random copolymer of propylene and ethylene and/or one or more C₄-C₂₀ alpha-olefins, a heterophasic propylene polymer material, or a combination thereof. In some embodiments, the random copolymer of propylene and ethylene and/or one or more C₄-C₂₀ alpha-olefins has a maximum content of ethylene and/or alpha-olefins of 10% by weight and an isotactic index of at least 80. In some embodiments, the a heterophasic propylene polymer consisting essentially of by weight, (i) 99 55% of a polymeric material selected from the group consisting of a propylene homopolymer having an isotactic index greater than 90, and a crystalline copolymer of propylene and an alpha-olefin of the formula CH₂═CHR, where R is H or a 2-6 carbon linear or branched alkyl group, having an isotactic index of at least 80, the alpha-olefin being less than 10% of the copolymer, and (ii) 1-45% of an elastomeric olefin polymer of propylene and an olefinic material selected from the group consisting of alpha-olefins of the formula CH₂═CHR, where R is H or a 2-6 carbon linear or branched alkyl group, the alpha-olefin being 50-70% of the elastomeric polymer.

When the polyolefin recyclate is a polypropylene recyclate, temperature in the visbreaking zone is lower than for polyethylene and an effective amount of peroxide is used to promote the desired level of chain scission. Suitable polypropylenes for polypropylene recyclates include a propylene homopolymers and copolymers of units derived from propylene and units derived one or more of ethylene and C₄-C₁₀ α-olefins or mixtures thereof. In some embodiments, the units derived from one or more of ethylene and C₄-C₁₀ α-olefin comonomers are present in amounts up to 35 wt. %, based upon the total weight of the copolymer of propylene. The propylene homopolymers and copolymers can be produced using either Ziegler Natta or single-site catalysts, e.g., metallocene catalysts. The propylene homopolymers and copolymers can be produced using a gas phase process, slurry process, or solution process. In some embodiments, when the propylene polymer is a copolymer, it contains 2 to 6 wt. %, based upon the total weight of the copolymer, of ethylene derived units as a comonomer.

A polyolefin recyclate can also be formed from a blend of two or more polyethylenes, two or more polypropylenes, or one or more polyethylenes and one or more polypropylenes.

In some embodiments, a the polyethylene recyclate is HDPE, as described above.

In some embodiments, a polyolefin recyclate comprises non-intentionally added substances (“NIAS”). NIAS are chemicals that are not purposefully included during the manufacturing of products but are present due to various reasons such as degradation, contamination, or reaction byproducts. In the context of recycled polyolefin, NIAS can come from several sources and include a wide range of substances. Common categories of NIAS include, but are not limited to, breakdown products of additives, reaction byproducts, contaminants from original use, contaminants from the recycling process, or a combination thereof. Additives such as stabilizers, plasticizers, and flame retardants can degrade into other chemicals. For example, antioxidants like Irganox™ might break down into smaller phenolic compounds, while plasticizers like phthalates can degrade into phthalic acid and its esters. During the recycling process, heat and mechanical stresses can cause chemical reactions that form new substances. For instance, the thermal degradation of the polyolefin can lead to the formation of alkenes and alkanes. Polyolefin products, in particular polyethylene products used for packaging, can absorb chemicals from the contents they held. For example, food packaging might contain traces of fats, oils, or food preservatives that migrate into the plastic. The process of collecting, sorting, and recycling can introduce contaminants. For instance, cellulose and adhesives from labels, inks from printing, and residues from cleaning agents can all become part of the recycled product. During the recycling process, different types of plastics might be mixed, leading to cross-contamination. Polar polymers such as, but not limited to, polyesters, acrylate polymers, maleic anhydride polymers, polyamides, vinyl alcohol polymers, polyvinyl chloride, vinyl acetate polymers, methyl methacrylate polymers, poly (butyl acrylate) and/or acrylic rubber, natural rubber and/or isoprene polymers, or a combination thereof.

### Visbreaking Conditions

Visbreaking conditions are implemented in the visbreaking zone of an extruder or other mixing apparatus and are tailored for specific polyolefins. When the polyolefin recyclate is a polyethylene recyclate, temperature in the visbreaking zone in some embodiments can be greater than or equal to 300° C., where it is believed that chain scission reactions exceed long-chain branching and/or crosslinking reactions. In other embodiments, temperatures in the visbreaking zone can be in the range of from 320° C. to 500° C., from 340° C. to 480° C., or from 360° C. to 460° C. In some embodiments, instrumentation at the first extruder discharge monitors rheology directly or indirectly (MI, HLMI, viscosity, or the like) to measure and assist in control of visbreaking. In some embodiments, where antioxidant addition is used in conjunction with visbreaking, the antioxidant addition point is at a location on the first extruder after a substantial portion of the visbreaking reaction has taken place.

In some embodiments, the polyolefin recyclate is added to a reaction zone suitable for implementing visbreaking conditions. Such reactions can be run in the conventional apparatuses generally used for processing polymers in the molten state. In particular, the polyolefin recyclate can be so processed in a reaction zone in an extruder device or a continuous mixer. These extruders or mixers can be single- or two-stage machines which melt and homogenize the polyolefin recyclate. Examples of extruders are pin-type extruders, planetary extruders, or corotating disk processors. Other possibilities are combinations of mixers with discharge screws and/or gear pumps. In some embodiments, extruders are screw extruders, such as, but not limited to, single-screw or twin-screw machines. In some embodiments, the reaction zone is in a twin-screw extruder or a continuous mixer with discharge elements, such as, but not limited to, continuous mixers with counter rotating twin rotor or the extruders comprising co-rotating twin screws. Machinery of this type is conventional in the plastics industry and is manufactured by, for example, Coperion GmbH, Stuttgart, Germany; KraussMaffei Berstorff GmbH, Hannover, Germany; The Japan Steel Works LTD., Tokyo, Japan; Farrel Corporation, Ansonia, USA; or Kobe Steel, Ltd., Kobe, Japan. Suitable extruder devices are further usually equipped with units for pelletizing the melt, such as underwater pelletizers.

The polyolefin recyclate is added to a reaction zone wherein visbreaking conditions are implemented to produce a treated polymer melt. Visbreaking conditions comprise adding specific energy to the polyolefin recyclate sufficient to initiate visbreaking but insufficient to initiate degradation of the polyolefin recyclate and reducing the pressure in at least a portion of the reaction zone to less than atmospheric pressure.

Visbreaking is a controlled process used specifically to reduce the molecular weight of polymers to a desired level to decrease the viscosity of the polymer for easier processing or to modify the flow properties to meet specific application needs. It is a carefully controlled process, typically involving the application of heat and mechanic shear forces within specific parameters to achieve a controlled reduction in molecular weight without significantly compromising overall properties. The breakdown in visbreaking is limited and controlled with a goal of reducing the molecular weight just enough to achieve desired changes in viscosity and processing characteristics, without causing extensive degradation that would impair the mechanical properties of the polymer.

In this context, polymer degradation refers to the breaking down of polymer chains to basic constituents, typically resulting in a loss of properties such as strength, elasticity, and color. Degradation can be intentional, such as depolymerization to produce monomers to recycle as feed to petrochemical processes but is undesirable where processing is intended yield a polymer product. Degradation can lead to a significant reduction in molecular weight and can severely impact polymer properties. Such breakdown can be extensive, leading to material that is no longer suitable for its original application.

Polyolefin recyclate is added to a reaction zone, wherein visbreaking conditions are implemented to produce a treated polymer melt. Visbreaking conditions comprise adding specific energy to the polyolefin recyclate sufficient to initiate visbreaking but insufficient to initiate degradation of the polyolefin recyclate and reducing the pressure in at least a portion of the rection zone to less than atmospheric pressure.

In one aspect, the present invention provides a process for extruding a polyolefin recyclate under visbreaking conditions. The process includes providing a polyolefin recyclate as described herein, conveying the resin through an extruder having a feed zone in which the resin is not melted, a melt-mixing zone in which at least a portion of the resin is melted, and one or more visbreaking zones in which the resin is in a molten state.

In some embodiments, 25% or more, 50% or more, 60% or more, 70% or more, 80% or more, or 90% or more of the length of the extruder comprise the one or more visbreaking zones, meaning that visbreaking conditions are implemented in 25% or more, 50% or more, 60% or more, 70% or more, 80% or more, or 90% or more of the length of the extruder.

In some embodiments, the pressure in at least a portion of the reaction zone is reduced to a pressure in the range of from 7.6 mm Hg absolute to 684 mm Hg absolute, from 22.8 mm Hg absolute to 532 mm Hg absolute, or from 38 mm Hg absolute to 380 mm Hg absolute, or less than or equal to 304 mm Hg absolute, less than or equal to 228 mm Hg absolute, less than or equal to 152 mm Hg absolute, or less than or equal to 76 mm Hg absolute.

In some embodiments of the method, visbreaking conditions comprise a temperature in the range of from 300° C. to 350° C., from 305° C. to 345° C., from 310° C. to 340° C., or from 315° C. to 335° C.

In some embodiments of the method, the specific energy added to the one or more reaction zones is in the range of from 0.30 hp·hr/lb to 0.60 hp·hr/lb, from 0.33 hp·hr/lb to 0.57 hp·hr/lb, from 0.37 hp·hr/lb to 0.53 hp·hr/lb, or from 0.40 hp·hr/lb to 0.50 hp·hr/lb.

In some embodiments of the method, the specific energy added to the one or more reaction zones is in the range of from 0.49 kW·hr/kg to 0.99 kW·hr/kg, from 0.54 kW·hr/kg to 0.94 kW·hr/kg, from 0.61 kW·hr/kg to 0.87 kW·hr/kg, or from 0.66 kW·hr/kg to 0.82 kW·hr/kg.

In some embodiments of the method, the wherein a residence time of the polyolefin recyclate in the reaction zone is in the range of from 5 seconds to 5 minutes, from 15 seconds to 4 minutes, or from 30 seconds to 3 minutes.

In some embodiments of the method, visbreaking conditions comprise injecting an inert gas into the reaction zone. In some embodiments, the inert gas is nitrogen. In some embodiments of the method, visbreaking conditions comprise injecting an air into the reaction zone. In some embodiments of the method, visbreaking conditions comprise injecting oxygen into the reaction zone.

In some embodiments of the method, the atmosphere in the reaction zone is maintained at a nitrogen content in the range of from 60 vol % to 100 vol %, from 65 vol % to 95 vol %, from 70 vol % to 90 vol %, or from 75 vol % to 85 vol %, and vol % is based on the total amount of oxygen and nitrogen.

In some embodiments of the method, the atmosphere in the reaction zone is maintained at an oxygen content in the range of from 0 vol % to 40 vol %, from 5 vol % to 35 vol %, from 10 vol % to 30 vol %, or from 15 vol % to 25 vol %, and vol % is based on the total amount of oxygen and nitrogen.

In some embodiments of the method, the reaction zone resides in an extruder. In some embodiments of the method, the extruder is a twin-screw extruder.

In some embodiments of the method, the pressure is reduced on the reaction zone at a location along the length of the extruder in the range of from 50% to 100%, from 60% to 100%, from 70% to 100%, from 80% to 100%, or from 90% to 100%, from a feed end of the extruder, wherein:
i) the polyolefin recyclate is added to the reaction zone proximate to the feed end of the extruder;
ii) the treated polymer melt is withdrawn from the reaction zone proximate to a discharge end of the extruder;
iii) the feed end is 0%; and
iv) the discharge end is 100%.

In some embodiments, the extruder (or other mixing apparatus) comprises one or more visbreaking zones. In some embodiments, at least a portion of the one or more visbreaking zones is are partially filled with the polymer melt, wherein the polymer melt in the one or more visbreaking zones is contacted with a gas. In some embodiments, the gas comprises nitrogen, oxygen, ambient air, or a mixture thereof.

In some embodiments, in addition to subjecting the polyolefin recyclate to visbreaking conditions, the polyolefin recyclate is treated by purging the gas in contact with the polymer melt with an inert gas. In some embodiments, the inert gas is nitrogen.

Although not wishing to bound by any particular theory, it is believed that adding nitrogen to the gas in contact with the polymer melt acts dilute the oxygen content of the gas in contact with the polymer melt. The reduced oxygen content of the gas in contact with the polymer melt serves to reduce the free radical initiator available to be consumed in a reaction where polymer chains on the surface of the polymer melt are broken into shorter chains. Although not wishing to be bound by theory, it is believed that an effect of adding an inert gas, such as nitrogen, will result in introducing a lesser amount of long chain branching in the resin or producing less of an increase long chain branching where it already exists.

In some embodiments, the method comprises injecting nitrogen into the reaction zone at a location along the length of the extruder in the range of from 0% to 50%, from 0% to 40%, from 0% to 30%, from 0% to 20%, or from 0% to 10%, from a feed end of the extruder, wherein:
i) the polyolefin recyclate is added to the reaction zone proximate to the feed end of the extruder;
ii) the treated polymer melt is withdrawn from the reaction zone proximate to a discharge end of the extruder;
iii) the feed end is 0%; and
iv) the discharge end is 100%.

In some embodiments, the nitrogen is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg.

In some embodiments, in addition to subjecting the polyolefin recyclate to visbreaking conditions, the polyolefin recyclate is treated by purging the gas in contact with the polymer melt with air.

Although not wishing to bound by any particular theory, it is believed that adding air to the gas in contact with the polymer melt acts replace oxygen content of the gas in contact with the polymer melt. The oxygen content of the gas in contact with the polymer melt is reduced as oxygen is consumed in a reaction where polymer chains on the surface of the polymer melt are broken into shorter chains with the consumed oxygen acting as a free radical initiator. Although not wishing to be bound by theory, it is believed that an effect of adding additional air brings the oxygen content of the gas contacting the polymer melt back to the level of oxygen in ambient air, resulting in introducing a greater amount of long chain branching in the resin than would occur without the addition of fresh air to the reaction zone.

In some embodiments, the method comprises injecting air into the reaction zone at a location along the length of the extruder in the range of from 0% to 50%, from 0% to 40%, from 0% to 30%, from 0% to 20%, or from 0% to 10%, from a feed end of the extruder, wherein:
i) the polyolefin recyclate is added to the reaction zone proximate to the feed end of the extruder;
ii) the treated polymer melt is withdrawn from the reaction zone proximate to a discharge end of the extruder;
iii) the feed end is 0%; and
iv) the discharge end is 100%.

In some embodiments, the air is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg.

In some embodiments, in addition to subjecting the polyolefin recyclate to visbreaking conditions, the polyolefin recyclate is treated with a free radical initiator, such as a peroxide or oxygen, capable of controlled degradation of the resin. Although not wishing to be bound by theory, it is believed that an effect of adding a free radical initiator to the process is to introduce low levels of long chain branching in the resin or increase long chain branching where it already exists.

In some embodiments, the free radical initiator will be oxygen in an amount in the range of from about 0.5 to about 8% by volume or from about 2 to about 6% by volume. When the free radical initiator used is oxygen, it can be conveniently introduced into the intensive mixer feed hopper. Concomitantly with carrying out the melt extrusion or pelletizing in the presence of a free radical initiator, antioxidant concentrations in the composition are generally reduced.

In some embodiments, the method comprises injecting oxygen into the reaction zone at a location along the length of the extruder in the range of from 0% to 50%, from 0% to 40%, from 0% to 30%, from 0% to 20%, or from 0% to 10%, from a feed end of the extruder, wherein:
i) the polyolefin recyclate is added to the reaction zone proximate to the feed end of the extruder;
ii) the treated polymer melt is withdrawn from the reaction zone proximate to a discharge end of the extruder;
iii) the feed end is 0%; and
iv) the discharge end is 100%.

In some embodiments, the oxygen is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg.

In some embodiments, the addition of free radical initiator, such as, but not limited to, oxygen and/or peroxide, is offset by addition of an antioxidant. In some embodiments, where antioxidant addition is used in conjunction with visbreaking, the antioxidant addition point is at a location on the first extruder after a substantial portion of the visbreaking reaction has taken place.

In some embodiments, visbreaking can be achieved with a twin screw extruder having at least: 1) a feed zone designed in such a way as to feed the available solid particles to a melt zone; 2) a melting zone designed to melt all the solids and impart an adequate amount of distributive and dispersive mixing; 3) a reaction zone designed to impart specific energy in a very short L: D to initiate visbreaking; 4) a quenching zone designed to lower the pressure and temperature of the melt to significantly reduce the thermal visbreaking, likely associated with venting; 5) a venting/vacuum section having reverse elements prior to the vent and neutral elements, or alternatively elements that provide a fill factor of less than 100%; and 5) a final section is having conveying elements to build up pressure for pelletization.

### Visbroken Polymer Recyclate Product

The polyolefin recyclate has a first melt index (MI₁). The treated polymer melt has a second melt index (MI₂). MI₂/MI₁ is greater than or equal to 3, greater than or equal to 10, greater than or equal to 15, greater than or equal to 20, or greater than or equal to 25.

In some embodiments of the method, the first melt index is an I₂ (ASTM D-1238, 2.16 kg, 190° C.) in the range of from 0.2 dg/min. to 2.5 dg/min. In some embodiments of the method, the first melt index is an I₂ (ASTM D-1238, 2.16 kg, 190° C.) greater than or equal to 2 dg/min., greater than or equal to 10 dg/min., greater than or equal to 10 dg/min., greater than or equal to 20 dg/min., greater than or equal to 25 dg/min., greater than or equal to 30 dg/min., or greater than or equal to 35 dg/min.

In some embodiments of the method, the first melt index is an I₂₁ (ASTM D-1238, 21.6 kg, 190° C.) in the range of from 5 dg/min. to 70 dg/min. In some embodiments of the method, the treated polymer melt has an I₂₁ (ASTM D-1238, 21.6 kg, 190° C.) greater than or equal to 200 dg/min., greater than or equal to 300 dg/min., greater than or equal to 400 dg/min., greater than or equal to 700 dg/min., greater than or equal to 750 dg/min., greater than or equal to 800 dg/min., or greater than or equal to 900 dg/min.

In some embodiments of the method, the polyolefin recyclate has an I₂ (ASTM D-1238, 2.16 kg, 190° C.) in the range of from 0.2 dg/min. to 2.5 dg/min. and an 121 (ASTM D-1238, 21.6 kg, 190° C.) in the range of from 5 dg/min. to 70 dg/min. In some embodiments of the method, the treated polymer melt has an I₂ (ASTM D-1238, 2.16 kg, 190° C.) greater than or equal to 2 dg/min., greater than or equal to 10 dg/min., greater than or equal to 10 dg/min., greater than or equal to 20 dg/min., greater than or equal to 25 dg/min., greater than or equal to 30 dg/min., or greater than or equal to 35 dg/min., and an I₂₁ (ASTM D-1238, 21.6 kg, 190° C.) greater than or equal to 200 dg/min., greater than or equal to 300 dg/min., greater than or equal to 400 dg/min., greater than or equal to 700 dg/min., greater than or equal to 750 dg/min., greater than or equal to 800 dg/min., or greater than or equal to 900 dg/min.

In some embodiments, the polyolefin recyclate has a first density (D₁), the treated polymer melt has a second density (D₂), and |D₁−D₂| is less than or equal to 0.005 g/cm³, less than or equal to 0.004 g/cm³, less than or equal to 0.003 g/cm³, less than or equal to 0.002 g/cm³, or less than or equal to 0.001 g/cm³.

In some embodiments, the polyolefin recyclate has a first number average molecular weight (Mₙ₁), the treated polymer melt has a second number average molecular weight (Mₙ₂), and (Mₙ₂)/(Mₙ₁) is less than or equal to 0.90, less than or equal to 0.80, or less than or equal to 0.70.

In some embodiments, the polyolefin recyclate has a first weight average molecular weight (M_{w1}), the treated polymer melt has a second weight average molecular weight (M_{w2}), and (M_{w2})/(M_{w1}) is less than or equal to 0.80, less than or equal to 0.70, or less than or equal to 0.60.

In some embodiments, the polyolefin recyclate has a first z-average molecular weight (M_{z1}), the treated polymer melt has a second z-average average molecular weight (M_{z2}), and (M_{z2})/(M_{z1}) is less than or equal to 0.60, less than or equal to 0.50, less than or equal to 0.40, or less than or equal to 0.25.

In some embodiments, the polyolefin recyclate has a first ratio of weight average molecular weight to number average molecular weight ((M_{w}/Mₙ)₁), the treated polymer melt has a second ratio of weight average molecular weight to number average molecular weight ((M_{w}/Mₙ)₂), and (M_{w}/Mₙ)₂/(M_{w}/Mₙ)₁ is less than or equal to 0.80, less than or equal to 0.70, less than or equal to 0.60, or less than or equal to 0.50.

In some embodiments, the polyolefin recyclate has a first ratio of weight average molecular weight to number average molecular weight ((M_{z}/M_{w})₁), the treated polymer melt has a second ratio of weight average molecular weight to number average molecular weight ((M_{z}/M_{w})₂), and (M_{z}/M_{w})₂/(M_{z}/M_{w})₁ is less than or equal to 0.90, less than or equal to 0.80, less than or equal to 0.70, or less than or equal to 0.60.

### Off-Gas Byproduct Stream

In some embodiments, the off-gas byproduct stream comprises water vapor and/or decomposition products generated under high heat and mechanical shear. The polyolefin can break down, releasing various hydrocarbons and possibly aldehydes and ketones. Additives in the polyolefin, such as antioxidants, stabilizers, plasticizers, or pigments, may also contribute volatiles when subjected to the heat and vacuum of the extrusion process. Low molecular weight hydrocarbons, cither from intentional reactions like visbreaking or unintentional degradation, can be vaporized under vacuum conditions.

In some embodiments, high temperature and mechanical shear from the visbreaking conditions can cause various NIAS to break down into hetero-containing gases, such as, but not limited to, carbon dioxide, acetaldehyde, chloromethane, acetic acid, methyl methacrylate, furfural, levoglucosenon, butanol, limonene, levoglucosan, caprolactam, HCl, glucopyranose, or a combination thereof. Some of these hetero-containing gases can act as free radical initiators to break down longer polymer chains and/or produce additional long chain branching.

### Blends of Treated Polyolefin Recyclate and Virgin Polymer

In some embodiments, a blend of a treated polyolefin recyclate and a virgin polymer is provided. For purposes of this section entitled, “Blends of Treated Polyolefin Recyclate and Virgin Polymer,” references to “treated polyolefin recyclate” shall include any of the embodiments described in the previous section entitled, “Treated Polyolefin Recyclates.”

A blend of treated polyolefin recyclate a virgin polymer can be formed from a blend of a tailored polyethylene recyclate and a virgin polyethylene, blend of a tailored polypropylene recyclate and a virgin polypropylene, blend of a tailored polyethylene recyclate and a virgin polypropylene, or blend of a tailored polypropylene recyclate and a virgin polyethylene.

In some embodiments, a blend comprises treated HDPE recyclate and a virgin HDPE.

Suitable polyethylenes for use as the virgin polymer include ethylene homopolymers and copolymers of units derived from ethylene and units derived from one or more of C₃-C₈ α-olefins or mixtures thereof. In some embodiments, the units derived from the one or more C₃-C₈ α-olefin comonomers are present in amounts up to 15 wt. %, based upon the total weight of the copolymer of ethylene. The ethylene homopolymers and copolymers can be produced using either Ziegler Natta or single-site catalysts, e.g., metallocene catalysts. The ethylene homopolymers and copolymers can be produced using a gas phase process, high pressure process, slurry process, or solution process. Ethylene homopolymers and ethylene-C₃-C₈ α-olefin copolymers include VLDPE, LDPE, LLDPE, MDPE, and HDPE, as described above.

Suitable polypropylenes for use as the virgin polymer include propylene homopolymers and copolymers of units derived from propylene and units derived one or more of ethylene and C₄-C₁₀ α-olefins or mixtures thereof. In some embodiments, the units derived from one or more of ethylene and C₄-C₁₀ α-olefin comonomers are present in amounts up to 35 wt. %, based upon the total weight of the copolymer of propylene. The propylene homopolymers and copolymers can be produced using either Ziegler Natta or single-site catalysts, e.g., metallocene catalysts. The propylene homopolymers and copolymers can be produced using a gas phase process, slurry process, or solution process. In some embodiments, when the propylene polymer is a copolymer, it contains 2 to 6 wt. %, based upon the total weight of the copolymer, of ethylene derived units as a comonomer.

A virgin polymer can also by formed from a blend of two or more polyethylenes, two or more polypropylenes, or one or more polyethylenes and one or more polypropylenes.

In some embodiments, a composition of polyethylene virgin polymer is HDPE, as described above.

In some embodiments, alone or in combination with the previous paragraphs in this section entitled, “Blends of Treated Polyolefin Recyclate and Virgin Polymer,” the blend comprises a from 5 wt. % to 90 wt. %, 10 wt. % to 80 wt. %, 15 wt. % to 70 wt. %, 20 wt. % to 60 wt. %, or 25 wt. % to 50 wt. %, of a treated polyolefin recyclate and from 10 wt. % to 95 wt. %, 20 wt. % to 90 wt. %, 30 wt. % to 85 wt. %, 40 wt. % to 80 wt. %, or 50 wt. % to 75 wt. %, of a virgin polymer, respectively, wherein all weight percentages are based on the combined weight of the polymer blend. In some embodiments, and one or both of the treated polyolefin recyclate and the virgin polymer are visbroken. Visbreaking can be thermal visbreaking and/or peroxidation visbreaking.

In some embodiments, alone or in combination with the previous paragraphs in this section entitled, “Blends of Treated Polyolefin Recyclate and Virgin Polymer,” the blend comprises a bimodal polymer, wherein the treated polyolefin recyclate product has a weight average molecular weight (“M_{w3}”), the virgin polymer has a weight average molecular weight (“M_{w4}”); and M_{w3}/M_{w4} is either less than or equal to 0.9, 0.8, 0.7, 0.6, or 0.5, or alternatively is greater than or equal to 1.1, 1.25, 1.5, 1.75, or 2.0.

Polyolefins with an outstanding combination of properties are so-called bimodal or multimodal polyolefins. These polyolefins are composed of two or more components having different compositions. The components of a multimodal polyolefin can differ with respect to the molecular weight and/or with respect to the comonomer composition. Multimodal polyolefin compositions are frequently prepared in a combination of two or more polymerization zones operated at different polymerization conditions. The two or more polymerization zones are usually arranged in a series of two or more polymerization reactors.

Multimodal polyolefins can be used in a wide range of applications. However, different applications need a different combination of polymer properties. Consequently, multimodal polyolefins designed to be used in different applications usually contain different components which vary with respect to molecular weight and comonomer composition and they usually contain different components in different amounts. Moreover, employing components having a narrow molecular weight distribution gives less overlap of the different components and accordingly allows a more precise tailoring of target polyolefin compositions.

The following examples illustrate the invention; however, those skilled in the art will recognize numerous variations within the spirit of the invention and scope of the claims. To facilitate a better understanding of the present invention, the following examples of some embodiments are given. In no way should the following examples be read to limit, or to define, the scope of the invention.

### Certain Embodiments

Disclosed is a method optimizing process conditions in a visbreaking process to increase the melt index of a polymer recyclate. In a first set of embodiments, the method for processing polyolefin recyclate comprises adding a polyolefin recyclate to a reaction zone. An amount of specific energy is added to the polyolefin recyclate in the form of mechanical shearing to produce a first treated polymer recyclate. Pressure is reduced on at least a portion of the reaction zone to less than atmospheric pressure. A second treated polymer recyclate and an off-gas byproduct stream are then withdrawn from the reaction zone. The polyolefin recyclate has a first melt index (MI₁). The second treated polymer recyclate has a second melt index (MI₂). MI₂/MI₁ is greater than or equal to 3, greater than or equal to 10, greater than or equal to 15, greater than or equal to 20, or greater than or equal to 25. In further embodiments, the treated polymer melt is pelletized to produce a treated polymer recyclate product. In some embodiments, MI₂/MI₁ is less than or equal 100 or less than or equal to 75.

In a second set of embodiments, in addition to the limitations of each of the foregoing embodiments of the first set of embodiments, the first treated polymer recyclate has a third melt index (MI₃), and MI₂/MI₃ is greater than or equal to 1.10, greater than or equal to 1.25, greater than or equal to 1.50, greater than or equal to 1.75, or greater than or equal to 2.0.

In a third set of embodiments, in addition to the limitations of each of the foregoing embodiments of the first set of embodiments and the second set of embodiments, the method is further characterized by one or more of the following:
a) the first melt index is an I₂ (ASTM D-1238, 2.16 kg, 190° C.) in the range of from 0.2 dg/min. to 2.5 dg/min.; and
b) the second treated polymer recyclate has an I₂ (ASTM D-1238, 2.16 kg, 190° C.) greater than or equal to 2 dg/min., greater than or equal to 10 dg/min., greater than or equal to 10 dg/min., greater than or equal to 20 dg/min., greater than or equal to 25 dg/min., greater than or equal to 30 dg/min., or greater than or equal to 35 dg/min.

In a fourth set of embodiments, in addition to the limitations of each of the foregoing embodiments of the first set of embodiments, second set of embodiments, or the third set of embodiments, the method is further characterized by one or more of the following:
a) the first melt index is an I₂₁ (ASTM D-1238, 21.6 kg, 190° C.) in the range of from 5 dg/min. to 70 dg/min.; and
b) the second treated polymer recyclate has an I₂₁ (ASTM D-1238, 21.6 kg, 190° C.) greater than or equal to 200 dg/min., greater than or equal to 300 dg/min., greater than or equal to 400 dg/min., greater than or equal to 700 dg/min., greater than or equal to 750 dg/min., greater than or equal to 800 dg/min., or greater than or equal to 900 dg/min.

In a sixth set of embodiments, in addition to the limitations of each of the foregoing embodiments of the first set of embodiments, the second set of embodiments, the third set of embodiments, the fourth set of embodiments, or the fifth set of embodiments, the method is further characterized by one or more of the following:
a) the polyolefin recyclate has a first density (D₁); the second treated polymer recyclate has a second density (D₂); and |D₁−D₂| is less than or equal to 0.005 g/cm³, less than or equal to 0.004 g/cm³, less than or equal to 0.003 g/cm³, less than or equal to 0.002 g/cm³, or less than or equal to 0.001 g/cm³;
b) the polyolefin recyclate has a first number average molecular weight (Mₙ₁); the second treated polymer recyclate has a second number average molecular weight (Mₙ₂); and (Mₙ₂)/(Mₙ₁) is less than or equal to 0.90, less than or equal to 0.80, or less than or equal to 0.70;
c) the polyolefin recyclate has a first weight average molecular weight (M_{w1}); the second treated polymer recyclate has a second weight average molecular weight (M_{w2}); and (M_{w2})/(M_{w1}) is less than or equal to 0.80, less than or equal to 0.70, or less than or equal to 0.60;
d) the polyolefin recyclate has a first z-average molecular weight (M_{z1}); the second treated polymer recyclate has a second z-average average molecular weight (M_{z2}); and (M_{z2})/(M_{z1}) is less than or equal to 0.60, less than or equal to 0.50, less than or equal to 0.40, or less than or equal to 0.25;
e) the polyolefin recyclate has a first ratio of weight average molecular weight to number average molecular weight ((M_{w}/Mₙ)₁); the second treated polymer recyclate has a second ratio of weight average molecular weight to number average molecular weight ((M_{w}/Mₙ)₂); and (M_{w}/Mₙ)₂/(M_{w}/Mₙ)₁ is less than or equal to 0.80, less than or equal to 0.70, less than or equal to 0.60, or less than or equal to 0.50;
f) the polyolefin recyclate has a first ratio of weight average molecular weight to number average molecular weight ((M_{z}/M_{w})₁); the second treated polymer recyclate has a second ratio of weight average molecular weight to number average molecular weight ((M_{z}/M_{w})₂); and (M_{z}/M_{w})₂/(M₂/M_{w})₁ is less than or equal to 0.90, less than or equal to 0.80, less than or equal to 0.70, or less than or equal to 0.60;
g) visbreaking conditions further comprise a temperature in the range of from 300° C. to 350° C., from 305° C. to 345° C., from 310° C. to 340° C., or from 315° C. to 335° C.;
h) the specific energy is in the range of from 0.49 kW·hr/kg to 0.99 kW·hr/kg, from 0.54 kW·hr/kg to 0.94 kW·hr/kg, from 0.61 kW·hr/kg to 0.87 kW·hr/kg, or from 0.66 kW·hr/kg to 0.82 kW·hr/kg;
i) the polyolefin recyclate comprises a polyethylene, a polypropylene, or a combination thereof; wherein in further embodiments:
   i) the polyethylene comprises: a high-density polyethylene (HDPE); a medium density polyethylene (MDPE); a low-density polyethylene (LDPE); a linear low-density polyethylene (LLDPE); or a combination thereof;
   ii) the polypropylene comprises: a propylene homopolymer; a random copolymer of propylene and ethylene and/or one or more C4-C20 alpha-olefins, wherein the maximum content of ethylene and/or alpha-olefins is 10% by weight, and the random copolymer has an isotactic index of at least 80; a heterophasic propylene polymer materials consisting essentially of by weight, (i) 99 55% of a polymeric material selected from the group consisting of a propylene homopolymer having an isotactic index greater than 90, and a crystalline copolymer of propylene and an alpha-olefin of the formula CH₂═CHR, where R is H or a 2-6 carbon linear or branched alkyl group, having an isotactic index of at least 80, the alpha-olefin being less than 10% of the copolymer, and (ii) 1-45% of an elastomeric olefin polymer of propylene and an olefinic material selected from the group consisting of alpha-olefins of the formula CH₂═CHR, where R is H or a 2-6 carbon linear or branched alkyl group, the alpha-olefin being 50-70% of the elastomeric polymer; or a combination thereof;
j) the pressure is reduced to a pressure in the range of from 7.6 mm Hg absolute to 684 mm Hg absolute, from 22.8 mm Hg absolute to 532 mm Hg absolute, or from 38 mm Hg absolute to 380 mm Hg absolute, or less than or equal to 304 mm Hg absolute, less than or equal to 228 mm Hg absolute, less than or equal to 152 mm Hg absolute, or less than or equal to 76 mm Hg absolute;
k) 25% or more, 50% or more, 60% or more, 70% or more, 80% or more, or 90% or more of the length of the extruder comprise the one or more visbreaking zones, meaning that visbreaking conditions are implemented in 25% or more, 50% or more, 60% or more, 70% or more, 80% or more, or 90% or more of the length of the extruder; and
l) a residence time in the reaction zone is in the range of from 5 seconds to 5 minutes, from 15 seconds to 4 minutes, or from 30 seconds to 3 minutes.

In a seventh set of embodiments, in addition to the limitations of each of the foregoing embodiments of the first set of embodiments, the second set of embodiments, the third set of embodiments, the fourth set of embodiments, the fifth set of embodiments, or the sixth set of embodiments, the method further comprises:
a) injecting an inert gas into the reaction zone, wherein in further embodiments, the inert gas is nitrogen;
b) injecting an air into the reaction zone;
c) injecting oxygen into the reaction zone; or
d) a combination thereof.

In an eighth set of embodiments, in addition to the limitations of each of the foregoing embodiments of the first set of embodiments, the second set of embodiments, the third set of embodiments, the fourth set of embodiments, the fifth set of embodiments, the sixth set of embodiments, or the seventh set of embodiments, the method further comprises:
a) maintaining the atmosphere in the reaction zone at a nitrogen content in the range of from 60 vol % to 100 vol %, from 65 vol % to 95 vol %, from 70 vol % to 90 vol %, or from 75 vol % to 85 vol %, and vol % is based on the total amount of oxygen and nitrogen;
b) maintaining the atmosphere in the reaction zone at an oxygen content in the range of from 0 vol % to 40 vol %, from 5 vol % to 35 vol %, from 10 vol % to 30 vol %, or from 15 vol % to 25 vol %, and vol % is based on the total amount of oxygen and nitrogen; or
c) a combination thereof.

In a ninth set of embodiments, in addition to the limitations of each of the foregoing embodiments of the first set of embodiments, the second set of embodiments, the third set of embodiments, the fourth set of embodiments, the fifth set of embodiments, the sixth set of embodiments, the seventh set of embodiments, or the eighth set of embodiments, the method is further characterized by the reaction zone residing in an extruder, wherein in further embodiments, the extruder is a twin-screw extruder. In further embodiments, the method is further characterized by one or more of the following:
a) the pressure is reduced on the reaction zone at a location along the length of the extruder in the range of from 50% to 100%, from 60% to 100%, from 70% to 100%, from 80% to 100%, or from 90% to 100%, from the feed end of the extruder, wherein: i) the polyolefin recyclate is added to the reaction zone proximate to the feed end of the extruder; ii) the second treated polymer recyclate is withdrawn from the reaction zone proximate to a discharge end of the extruder; iii) the feed end is 0%; and iv) the discharge end is 100%;
b) the method further comprises injecting nitrogen into the reaction zone at a location along the length of the extruder in the range of from 0% to 50%, from 0% to 40%, from 0% to 30%, from 0% to 20%, or from 0% to 10%, from the feed end of the extruder, wherein: i) the polyolefin recyclate is added to the reaction zone proximate to the feed end of the extruder; ii) the second treated polymer recyclate is withdrawn from the reaction zone proximate to a discharge end of the extruder; iii) the feed end is 0%; and iv) the discharge end is 100%; wherein in further embodiments, the nitrogen is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg.
c) the method further comprises injecting air into the reaction zone at a location along the length of the extruder in the range of from 0% to 50%, from 0% to 40%, from 0% to 30%, from 0% to 20%, or from 0% to 10%, from the feed end of the extruder, wherein: i) the polyolefin recyclate is added to the reaction zone proximate to the feed end of the extruder; ii) the second treated polymer recyclate is withdrawn from the reaction zone proximate to a discharge end of the extruder; iii) the feed end is 0%; and iv) the discharge end is 100%; wherein in further embodiments, the air is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg;
d) method further comprises injecting oxygen into the reaction zone at a location along the length of the extruder in the range of from 0% to 50%, from 0% to 40%, from 0% to 30%, from 0% to 20%, or from 0% to 10%, from the feed end of the extruder, wherein: i) the polyolefin recyclate is added to the reaction zone proximate to the feed end of the extruder; ii) the second treated polymer recyclate is withdrawn from the reaction zone proximate to a discharge end of the extruder; iii) the feed end is 0%; and iv) the discharge end is 100%; wherein in further embodiments, the oxygen is injected into the reaction zone at a rate in std. ft³ per lb. of polymer (scf/lb) in the range of from 0.2 scf/lb to 1.5 scf/lb, from 0.3 scf/lb to 1.1 scf/lb, 0.4 scf/lb to 0.9 scf/lb, 0.5 scf/lb to 0.7 scf/lb, or in std. L per kg of polymer (sL/kg) in the range of from 12.5 sL/kg to 93.5 sL/kg, from 18.7 sL/kg to 68.6 sL/kg, 24.9 sL/kg to 56.1 sL/kg, 31.2 sL/kg to 43.6 sL/kg; or
e) a combination thereof.

### EXAMPLES

The following examples are included to demonstrate some embodiments of the invention. It should be appreciated by those of skill in the art that the techniques disclosed in the examples which follow represent techniques discovered by the inventor to function well in the practice of the invention, and thus can be considered to constitute enabling modes for its practice. However, those of skill in the art should, in light of the present disclosure, appreciate that many changes can be made in the specific embodiments which are disclosed and still obtain a like or similar result without departing from the spirit and scope of the invention.

### Test Methods

Complex viscosity (“η*”) was determined by ASTM D-4440.

Densities are determined in accordance with ASTM D-4703 and ASTM D-1505/ISO-1183.

High load melt index (“I₂₁”) was determined by ASTM D-1238-F (190° C./21.6 kg).

Melt flow rate for polypropylene (“MFR”) is measured by ASTM D-1238-E (190° C./2.16 kg).

Melt index for polyethylene (“MI” or “I_{2.16}”) is measured by ASTM D-1238-E (190° C./2.16 kg).

Molecular weight distribution (“MWD”) as well as the number average molecular weight (“Mₙ”) and weight average molecular weight (“M_{w}”), are determined using gel permeation chromatography (“GPC”), also referred to as size exclusion chromatography (“SEC”). GPC is a separation technique in which molecules are separated on the basis of hydrodynamic molecular volume or size. With proper column calibration or by the use of molecular-weight-sensitive detectors, such as light scattering or viscometry, the molecular weight distribution and the statistical molecular weight averages can be obtained. In GPC, molecules pass through a column via a combination of transport into and through beads along with between beads in the column. The time required for passage of a molecule through the column is decreased with increasing molecular weight. The amount of polymer exiting the column at any given time is measured with various detectors. A more in depth description of the instrumentation and detectors can be found in the chapter titled “Composition, Molar Mass and Molar Mass Distribution” in Characterization and Analysis of Polymers by Ron Clavier (2008).

Shear rheological measurements are performed in accord with ASTM 4440-95a, which characterize dynamic viscoelastic properties (storage modulus, G′, loss modulus, G″ and complex viscosity, η*, as a function of oscillation frequency, ω). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is approximately 10% and the operating gap is set at 1 mm. Nitrogen flow was applied in the sample chamber to minimize thermal oxidation during the measurement.

Specific energy, as used herein, means viscous dissipation of heat into polymer in an extruder. This viscous dissipation of heat is mechanical energy transmitted from the extruder motor and dissipated as heat into the polymer and is calculated as consumed mechanical energy (motor horsepower or kW) divided by the throughput rate (lb/hr or kg/hr) of the extruder. If a meaningful amount of conductive heat was added to an extruder the thermal energy input would be calculated as the power of the heat source (horsepower or kW) divided by the throughput rate (lb/hr or kg/hr) of the extruder. In this case, the specific energy would be the sum of the mechanical energy and the thermal energy divided by the throughput (hp·hr/lb or kW·hr/kg)

Melt elasticity (“ER”) is determined as discussed in R. Shroff and H. Mavridis, “New Measures of Polydispersity from Rheological Data on Polymer Melts,” J. Applied Polymer Science 57 (1995) 1605. See also U.S. Pat. Nos. 7,238,754, 6, 171,993 and 5,534,472 (col. 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

$$ER = ( 1.781 \times {10}^{- 3} ) \times {G}^{′}$$

at a value of G″=5,000 dyn/cm². The same procedure and equation for the ER calculation was used for both linear and long-chain-branched polyolefins.

Melt index (“I₂”) was determined by ASTM D-1238-E (190° C./2.16 kg).

PDR, or “Overall Polydispersity Measure” is determined as discussed in R. Shroff and H. Mavridis, “New Measures of Polydispersity from Rheological Data on Polymer Melts,” J. Applied Polymer Science 57 (1995) 1605, equation 27 on page 1619, with G*_{ref.1}=1.95*10⁴ dyn/cm² and log 10 (G*_{ref.3}/G*_{ref.1})=2. The same procedure and equation for the PDR calculation was used for both linear and long-chain-branched polyolefins.

The ratio

$${η}_{0.1}^{*} / {η}_{100}^{*}$$

of complex viscosities,

$${η}_{0.1}^{*} ,$$

at a frequency of 0.1 rad/sec and

$${η}_{100}^{*} ,$$

at a frequency of 100 rad/sec, is used as an additional measure of shear sensitivity and thus rheological breadth, or polydispersity, of the polymer melt.

LCBI is determined using equation 13:

$$LCBI = \frac{{η}_{0}^{0.179}}{[ η ]} \frac{1}{4.8} - 1 \qquad ( 13 )$$

Equation 13 and its application are described in of Shroff & Mavridis, (1999) “A Long Chain Branching Index for Essentially Linear Polyethylenes”, Macromolecules, 32, 8454-8464, the disclosure of which is fully incorporated by reference herein in its entirety.

Long Chain Branching frequency, characterized by the ratio of Long Chain Branches per million carbon atoms, or LCB/10⁶ C, was determined by the method of Janzen & Colby (J. Janzen and R. H. Colby, “Diagnosing long-chain branching in polyethylenes”, Journal of Molecular Structure, Vol 485-486, 10 Aug. 1999, Pages 569-583), using eqs. (2-3) and the constants of Table 2 in the above reference. Specifically, the zero-shear viscosity at 190° C.,

$${η}_{0}^{*} ,$$

is determined by extrapolation of the complex viscosity data via the Sabia equation, as described separately. The weight-average-molecular weight, Mw, is determined via GPC. With these two parameters and the methodology of Janzen & Colby, the Long Chain Branching frequency, LCB/10⁶ C, can be determined numerically such that all 3 parameters (η₀, M_{w} and LCB/10⁶ C) satisfy eqs. (2-3) in the above reference. The Janzen & Colby methodology predicts that the ratio, η₀/η_{0,linear} of the zero-shear viscosity of the material, over the zero-shear viscosity of a perfectly linear polymer (LCB/10⁶ C=0) of the same average molecular weight, exhibits a maximum at a certain value of LCB/10⁶ C and therefore for every value of η₀/η_{0,linear}, there exist two levels, or values, of LCB/10⁶ C that such ratio is possible. For the purposes of the present calculations, the lowermost value of LCB/10⁶ C was always selected at the given ratio of η₀/η_{0,linear}.

Molecular weight distribution (“MWD”) as well as the molecular weight averages (number-average molecular weight, Mₙ, weight-average molecular weight, M_{w}, and z-average molecular weight, M_{z}) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z}, MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

$${g}^{′} = [ η ] {/ [ η ]}_{lin}$$

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation

$$( {[ η ]}_{lin} = \sum {KM}_{i}^{α} )$$

for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Zero-shear viscosity, η₀, is determined using the Sabia equation fit of dynamic complex viscosity versus radian frequency, as described in of Shroff & Mavridis, (1999) “A Long Chain Branching Index for Essentially Linear Polyethylenes”, Macromolecules, 32, 8454-8464 (with focus on Appendix B), the disclosure of which is fully incorporated by reference herein in its entirety.

### Raw Materials

Raw materials used herein are shown in Table 1, below.

TABLE 1

| | | MI | Density | | |
|---|---|---|---|---|---|
| Composition | Grade | (dg/min)* | (g/cm³) | Available from | Label |
| HDPE recyclate | EcoPrime ™ HDPE | 0.60 | 0.961 | Envision Plastics | P1 |
| LLDPE recyclate | LLDPE Clear 410500 | 2.0 | 0.926 | EFS Plastics | P2 |
| LLDPE recyclate | Natura PCR-LLDPCR- | 2.2 | 0.920 | Avangard | P3 |
| | 100 | | | Innovative | |
| LDPE recyclate | Natura PCR-LDPCR- | 0.8 | 0.933 | Avangard | P4 |
| | 150 | | | Innovative | |

*190° C./2.16 kg

### Visbreaking Conditions

Extruder 1

Extruder 1 was a Werner and Pfleiderer ZSK40 co-rotating twin screw extruder with 12 barrel sections operating at a feed rate of 50 pounds per hour, a screw speed of 590 rpm and with a target temperature profile of 38/200/250/325/325/325/325/325/325/325/325/325° C. (from feed inlet to die). There were nitrogen injection points into the first and seventh barrel sections. There was an atmospheric vent from the fifth section. There was a vacuum vent on the tenth section. The examples below identify when the nitrogen injection into both the first and seventh barrel sections was turned on or off. The examples below further identify when the vacuum vent was on or off.
Extruder 2

Extruder 2 was a Werner and Pfleiderer ZSK40 co-rotating twin screw extruder with 10 barrel sections operating at a feed rate of 50 pounds per hour, a screw speed of 600 rpm and with a target temperature profile of 38/200/250/325/325/325/325/325/325/325/° C. (from feed inlet to die). There was a nitrogen injection point into the first barrel section. There was no atmospheric vent. There was a vacuum vent on the tenth section. The examples below identify when the vacuum vent was on or off.
HDPE recyclate

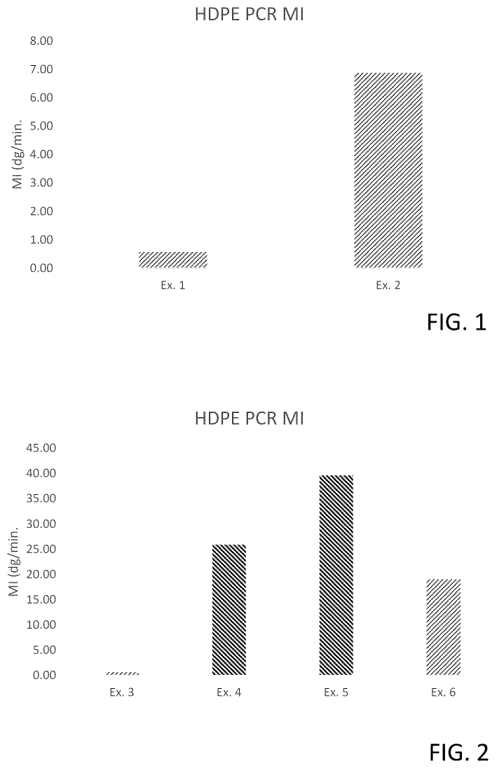

Table 2 shows a comparison of an HDPE PCR to a visbroken HDPE PCR. Example 1 shows measured properties for neat sample of P1. Example 2 shows measured properties for a visbroken sample of P1. Examples 1 and 2 show that melt index of HDPE PCR is increased by a factor of 12 where melt index is MI (i.e., MI₂/MI₁) and by a factor of 5 where melt index is HLMI (i.e., HLMI₂/HLMI₁) where visbreaking conditions are implemented at a pressure greater than or equal to atmospheric pressure. FIG. 1 shows a comparison of MI for P1 and P1 visbroken in Extruder 2.

TABLE 2

| Example | 1 | 2 |
|---|---|---|
| Polymer | P1 | P1 |
| Visbroken | No | Yes |
| Extruder | N/A | 2 |
| N₂ Injection | N/A | Yes |
| Vacuum applied | N/A | No |
| MI (dg/min.) | 0.57 | 6.88 |
| MI/Ex. 1 MI | N/A | 12 |
| HLMI | 58 | 287 |
| HLMI/Ex. 1 HLMI | N/A | 5 |
| HLMI/MI | 101 | 42 |
| Density (g/cm³) | 0.961 | 0.961 |
| ER | 4.87 | 1.14 |
| ER/Ex. 1 ER | 100% | 23% |
| PDR | 33 | 7 |
| PDR/Ex. 1 PDR | 100% | 23% |
| η₀ | 1.29E+07 | 2.01E+04 |
| η*_{0.1} | 2.25E+05 | 1.83E+04 |
| η*₁₀₀ | 1.06E+04 | 4.04E+03 |
| η*_{0.1}/η*₁₀₀ | 21.2 | 4.5 |
| Mₙ | 16,889 | 14,939 |
| Mₙ/Ex. 1 Mₙ | N/A | 0.88 |
| M_{w} | 126,500 | 61,100 |
| M_{w}/Ex. 1 M_{w} | 100% | 48% |
| M_{z} | 606,200 | 141,400 |
| M_{z}/Ex. 1 M_{z} | 100% | 23% |
| M_{w}/Mₙ | 7.5 | 4.1 |
| (M_{w}/Mₙ)/Ex. 1 | N/A | 0.55 |
| (M_{w}/Mₙ) | | |
| M_{z}/M_{w} | 4.8 | 2.3 |
| (M_{z}/M_{w})/Ex. 1 | 100% | 48% |
| (M_{z}/M_{w}) | | |
| IV | 1.53 | 0.94 |
| g′ | 0.96 | 0.92 |
| LCBI | 1.55 | 0.31 |
| LCB/10⁶ C | 94 | 100 |
| Yellowness Index | — | — |
| SPE (hp · hr/lb) | N/A | 0.329 |
| SPE (kW · hr/kg) | N/A | 0.541 |

Table 3 shows a comparison of an HDPE PCR to a visbroken HDPE PCR. Example 3 shows measured properties for neat sample of P1. Examples 4-6 show measured properties for a visbroken samples of P1.

Examples 3 and 6 show that melt index of HDPE PCR is increased by a factor of 32 where melt index is MI (i.e., MI₂/MI₁) and by a factor of 13 where melt index is HLMI (i.e., HLMI₂/HLMI₁) where visbreaking conditions are implemented at a pressure greater than or equal to atmospheric pressure without nitrogen injection into the extruder. Examples 3 and 4 show that melt index of HDPE PCR is increased by a factor of 44 where melt index is MI (i.e., MI₂/MI₁) and by a factor of 17 where melt index is HLMI (i.e., HLMI₂/HLMI₁) where visbreaking conditions are implemented under vacuum with nitrogen injection into the extruder. Examples 3 and 5 show that melt index of HDPE PCR is increased by a factor of 67 where melt index is MI (i.e., MI₂/MI₁) and by a factor of 26 where melt index is HLMI (i.e., HLMI₂/HLMI₁) where visbreaking conditions are implemented under vacuum with nitrogen injection into the extruder. FIG. 2 shows a comparison of MI for P1 and P1 visbroken in Extruder 1 with and without nitrogen addition and with and without vacuum conditions in the extruder.

TABLE 3

| Example | 3 | 4 | 5 | 6 |
|---|---|---|---|---|
| Polymer | P1 | P1 | P1 | P1 |
| Visbroken | No | Yes | Yes | Yes |
| Extruder | N/A | 1 | 1 | 1 |
| N₂ Injection | N/A | Yes | No | No |
| Vacuum applied | N/A | Yes | Yes | No |
| MI (dg/min.) | 0.59 | 26 | 40 | 19 |
| MI/Ex. 1 MI | N/A | 44 | 67 | 32 |
| HLMI (dg/min.) | 58 | 993 | 1520 | 733 |
| HLMI/Ex. 1 HLMI | N/A | 17 | 26 | 13 |
| HLMI/MI | 98 | 38 | 38 | 39 |
| Density (g/cm³) | 0.961 | 0.961 | 0.959 | 0.960 |
| ER | 4.90 | 0.88 | 0.92 | 0.87 |
| ER/Ex. 1 ER | 100% | 18% | 19% | 18% |
| PDR | 34 | 6.2 | 6.5 | 5.9 |
| PDR/Ex. 1 PDR | 100% | 18% | 19% | 17% |
| η₀ | 1.56E+07 | 4.99E+03 | 3.41E+03 | 6.51E+03 |
| η*_{0.1} | 2.27E+05 | 4.80E+03 | 3.28E+03 | 6.27E+03 |
| η*₁₀₀ | 1.04E+04 | 1.90E+03 | 1.42E+03 | 2.28E+03 |
| η*_{0.1}/η*₁₀₀ | 21.8 | 2.5 | 2.3 | 2.8 |
| Mₙ | 15,311 | 11,622 | 10,389 | 11,962 |
| Mₙ/Ex. 1 Mₙ | N/A | 0.76 | 0.68 | 0.78 |
| M_{w} | 125,700 | 47,300 | 45,400 | 50,000 |
| M_{w}/Ex. 1 M_{w} | 100% | 38% | 36% | 40% |
| M_{z} | 591,500 | 111,000 | 114,900 | 111,900 |
| M_{z}/Ex. 1 M_{z} | 100% | 19% | 19% | 19% |
| M_{w}/Mₙ | 8.2 | 4.1 | 4.4 | 4.2 |
| (M_{w}/Mₙ)/Ex. 1 (M_{w}/Mₙ) | N/A | 0.50 | 0.53 | 0.51 |
| M_{z}/M_{w} | 4.7 | 2.3 | 2.5 | 2.2 |
| (M_{z}/M_{w})/Ex. 1 (M_{z}/M_{w}) | 100% | 50% | 54% | 48% |
| IV | 1.52 | 0.73 | 0.68 | 0.79 |
| g′ | 0.96 | 0.87 | 0.84 | 0.90 |
| LCBI | 1.66 | 0.31 | 0.31 | 0.27 |
| LCB/10⁶ C | 100 | 100 | 100 | 100 |
| Yellowness Index | 19 | 25 | 28 | 27 |
| SPE (hp · hr/lb) | N/A | 0.340 | 0.340 | 0.340 |
| SPE (kW · hr/kg) | N/A | 0.559 | 0.559 | 0.559 |

LLDPE recyclate

Table 4 shows a comparison of an HDPE PCR to a visbroken HDPE PCR. Example 7 shows measured properties for neat sample of P2. Examples 8 and 9 show measured properties for a visbroken sample of P2.

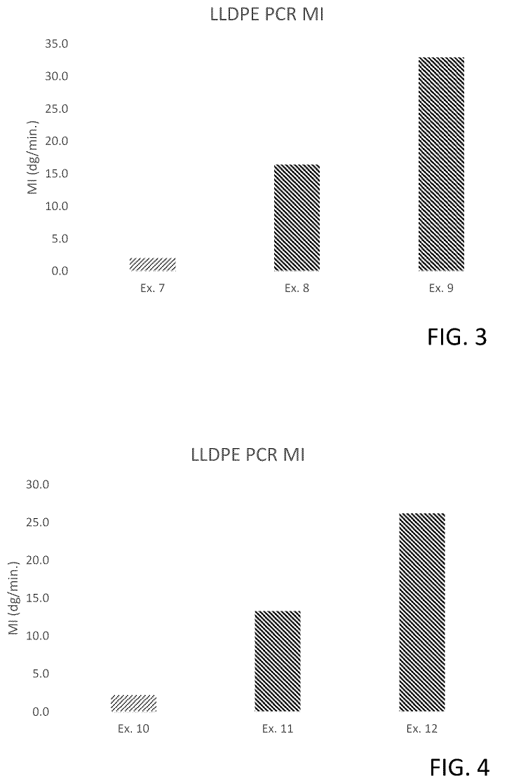

Examples 7 and 8 show that melt index of HDPE PCR is increased by a factor of about 8 where melt index is MI (i.e., MI₂/MI₁) and by a factor of about 6 where melt index is HLMI (i.e., HLMI₂/HLMI₁) where visbreaking conditions are implemented at a pressure greater than or equal to atmospheric pressure without nitrogen injection into the extruder. Examples 7 and 9 show that melt index of HDPE PCR is increased by a factor of about 16 where melt index is MI (i.e., MI₂/MI₁) and by a factor of about 15 where melt index is HLMI (i.e., HLMI₂/HLMI₁) where visbreaking conditions are implemented under vacuum with nitrogen injection into the extruder. FIG. 3 shows a comparison of MI for P2 and P2 visbroken in Extruder 2, with and without vacuum conditions in Extruder 2.

TABLE 4

| Example | 7 | 8 | 9 |
|---|---|---|---|
| Polymer | P2 | P2 | P2 |
| Visbroken | No | Yes | Yes |
| Extruder | N/A | 2 | 2 |
| N₂ Injection | N/A | Yes | Yes |
| Vacuum applied | N/A | No | Yes |
| MI (dg/min.) | 2.0 | 16.4 | 32.9 |
| MI/Ex. 1 MI | N/A | 8.1 | 16.3 |
| HLMI (dg/min.) | 60.6 | 390 | 892 |
| HLMI/Ex. 1 HLMI | N/A | 6.4 | 14.7 |
| HLMI/MI | 30 | 24 | 27 |
| Density (g/cm³) | 0.926 | 0.910 | 0.930 |
| ER | 1.24 | 0.86 | 0.8 |
| ER/Ex. 1 ER | 100% | 69% | 65% |
| PDR | 5.03 | 3.04 | 3.41 |
| PDR/Ex. 1 PDR | 100% | 60% | 68% |
| η₀ | 9.27E+04 | 7.02E+03 | 3.63E+03 |
| η*_{0.1} | 6.19E+04 | 6.38E+03 | 3.45E+03 |
| η*₁₀₀ | 1.12.E+04 | 2.97.E+03 | 1.78.E+03 |
| η*_{0.1}/η*₁₀₀ | 5.5 | 2.1 | 1.9 |
| Mₙ | 24,842 | 19,215 | 15,833 |
| Mₙ/Ex. 1 Mₙ | N/A | 0.77 | 0.64 |
| M_{w} | 109,800 | 63,600 | 51,300 |
| M_{w}/Ex. 1 M_{w} | 100% | 58% | 47% |
| M_{z} | 306,300 | 145,700 | 120,800 |
| M_{z}/Ex. 1 M_{z} | 100% | 48% | 39% |
| M_{w}/Mₙ | 4.42 | 3.31 | 3.24 |
| (M_{w}/Mₙ)/Ex. 1 | N/A | 0.75 | 0.73 |
| (M_{w}/Mₙ) | | | |
| M_{z}/M_{w} | 2.79 | 2.29 | 2.35 |
| (M_{z}/M_{w})/Ex. 1 | 100% | 82% | 84% |
| (M_{z}/M_{w}) | | | |
| IV | 1.54 | 1.06 | 0.90 |
| g′ | 0.90 | 0.86 | 0.84 |
| LCBI | 0.05 | −0.04 | 0.00 |
| LCB/10⁶ C | 17 | 32 | 68 |
| Yellowness Index | 35 | 36 | 32 |
| SPE (hp · hr/lb) | N/A | 0.315 | 0.312 |
| SPE (kW · hr/kg) | N/A | 0.518 | 0.513 |

LLDPE recyclate

Table 5 shows a comparison of an HDPE PCR to a visbroken HDPE PCR. Example 10 shows measured properties for neat sample of P3. Examples 11 and 12 show measured properties for a visbroken sample of P3.

Examples 10 and 11 show that melt index of HDPE PCR is increased by a factor of about 6 where melt index is MI (i.e., MI₂/MI₁) and by a factor of about 5 where melt index is HLMI (i.e., HLMI₂/HLMI₁) where visbreaking conditions are implemented at a pressure greater than or equal to atmospheric pressure without nitrogen injection into the extruder. Examples 10 and 12 show that melt index of HDPE PCR is increased by a factor of about 12 where melt index is MI (i.e., MI₂/MI₁) and by a factor of about 12 where melt index is HLMI (i.e., HLMI₂/HLMI₁) where visbreaking conditions are implemented under vacuum with nitrogen injection into the extruder. FIG. 4 shows a comparison of MI for P3 and P3 visbroken in Extruder 2, with and without vacuum conditions in Extruder 2.

TABLE 5

| Example | 13 | 14 | 15 |
|---|---|---|---|
| Polymer | P3 | P3 | P3 |
| Visbroken | No | Yes | Yes |
| Extruder | N/A | 2 | 2 |
| N₂ Injection | N/A | Yes | Yes |
| Vacuum applied | N/A | No | Yes |
| MI (dg/min.) | 2.2 | 13.3 | 26.2 |
| MI/Ex. 1 MI | N/A | 6.0 | 11.9 |
| HLMI (dg/min.) | 62.2 | 316 | 758 |
| HLMI/Ex. 1 HLMI | N/A | 5.1 | 12.2 |
| HLMI/MI | 28 | 24 | 29 |
| Density (g/cm³) | 0.920 | 0.905 | 0.924 |
| ER | 1.06 | 0.83 | 0.97 |
| ER/Ex. 1 ER | 100% | 78% | 92% |
| PDR | 4.34 | 2.79 | 3.43 |
| PDR/Ex. 1 PDR | 100% | 64% | 79% |
| η₀ | 7.79E+04 | 8.98E+03 | 5.21E+03 |
| η*_{0.1} | 5.48E+04 | 8.13E+03 | 4.77E+03 |
| η*₁₀₀ | 1.13.E+04 | 3.92.E+03 | 2.20.E+03 |
| η*_{0.1}/η*₁₀₀ | 4.8 | 2.1 | 2.2 |
| Mₙ | 26,814 | 20,692 | 16,877 |
| Mₙ/Ex. 1 Mₙ | N/A | 0.77 | 0.63 |
| M_{w} | 109,400 | 65,800 | 53,500 |
| M_{w}/Ex. 1 M_{w} | 100% | 60% | 49% |
| M_{z} | 274,600 | 140,500 | 108,600 |
| M_{z}/Ex. 1 M_{z} | 100% | 51% | 40% |
| M_{w}/Mₙ | 4.08 | 3.18 | 3.17 |
| (M_{w}/Mₙ)/Ex. 1 | N/A | 0.78 | 0.78 |
| (M_{w}/Mₙ) | | | |
| M_{z}/M_{w} | 2.51 | 2.14 | 2.03 |
| (M_{z}/M_{w})/Ex. 1 | 100% | 85% | 81% |
| (M_{z}/M_{w}) | | | |
| IV | 1.55 | 1.09 | 0.94 |
| g′ | 0.89 | 0.88 | 0.85 |
| LCBI | 0.01 | −0.02 | 0.03 |
| LCB/10⁶ C | 15 | 32 | 77 |
| Yellowness Index | 26 | 33 | 28 |
| SPE (hp · hr/lb) | N/A | 0.313 | 0.307 |
| SPE (kW · hr/kg) | N/A | 0.515 | 0.505 |

LDPE recyclate

Table 6 shows a comparison of an HDPE PCR to a visbroken HDPE PCR. Example 13 shows measured properties for neat sample of P4. Examples 14 and 15 show measured properties for a visbroken sample of P4.

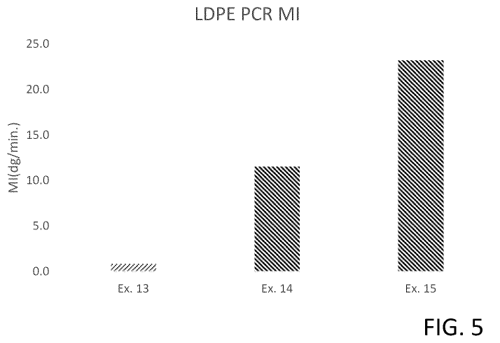

Examples 13 and 14 show that melt index of HDPE PCR is increased by a factor of about 14 where melt index is MI (i.e., MI₂/MI₁) and by a factor of about 10 where melt index is HLMI (i.e., HLMI₂/HLMI₁) where visbreaking conditions are implemented at a pressure greater than or equal to atmospheric pressure without nitrogen injection into the extruder. Examples 13 and 15 show that melt index of HDPE PCR is increased by a factor of about 27 where melt index is MI (i.e., MI₂/MI₁) and by a factor of about 22 where melt index is HLMI (i.e., HLMI₂/HLMI₁) where visbreaking conditions are implemented under vacuum with nitrogen injection into the extruder. FIG. 5 shows a comparison of MI for P4 and P4 visbroken in Extruder 2, with and without vacuum conditions in Extruder 2.

TABLE 6

| Example | 13 | 14 | 15 |
|---|---|---|---|
| Polymer | P4 | P4 | P4 |
| Visbroken | No | Yes | Yes |
| Extruder | N/A | 2 | 2 |
| N₂ Injection | N/A | Yes | Yes |
| Vacuum applied | N/A | No | Yes |
| MI (dg/min.) | 0.8 | 11.5 | 23.2 |
| MI/Ex. 1 MI | N/A | 13.6 | 27.4 |
| HLMI (dg/min.) | 32.3 | 306 | 711 |
| HLMI/Ex. 1 HLMI | N/A | 9.5 | 22.0 |
| HLMI/MI | 38 | 27 | 31 |
| Density (g/cm³) | 0.933 | 0.936 | 0.937 |
| ER | 1.87 | 0.82 | 0.85 |
| ER/Ex. 1 ER | 100% | 44% | 45% |
| PDR | 10.10 | 4.21 | 4.77 |
| PDR/Ex. 1 PDR | 100% | 42% | 47% |
| η₀ | 3.58E+05 | 1.11E+04 | 5.46E+03 |
| η*_{0.1} | 1.31E+05 | 1.03E+04 | 5.19E+03 |
| η*₁₀₀ | 1.21.E+04 | 3.71.E+03 | 2.15.E+03 |
| η*_{0.1}/η*₁₀₀ | 10.8 | 2.8 | 2.4 |
| Mₙ | 22,633 | 17,829 | 14,883 |
| Mₙ/Ex. 1 Mₙ | N/A | 0.79 | 0.66 |
| M_{w} | 127,200 | 69,000 | 57,000 |
| M_{w}/Ex. 1 M_{w} | 100% | 54% | 45% |
| M_{z} | 397,200 | 163,900 | 146,700 |
| M_{z}/Ex. 1 M_{z} | 100% | 41% | 37% |
| M_{w}/Mₙ | 5.62 | 3.87 | 3.83 |
| (M_{w}/Mₙ)/Ex. 1 | N/A | 0.69 | 0.68 |
| (M_{w}/Mₙ) | | | |
| M_{z}/M_{w} | 3.12 | 2.38 | 2.57 |
| (M_{z}/M_{w})/Ex. 1 | 100% | 76% | 82% |
| (M_{z}/M_{w}) | | | |
| IV | 1.68 | 1.11 | 0.96 |
| g′ | 0.85 | 0.82 | 0.80 |
| LCBI | 0.22 | −0.01 | 0.01 |
| LCB/10⁶ C | 19 | 30 | 47 |
| Yellowness Index | 26 | 44 | 31 |
| SPE (hp · hr/lb) | N/A | 0.315 | 0.312 |
| SPE (kW · hr/kg) | N/A | 0.518 | 0.513 |

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, means, processes, and/or steps described in the specification. As one of the ordinary skill in the art will readily appreciate from the disclosure of the present invention, processes, machines, means, processes, and/or steps, presently existing or later to be developed that perform substantially the same function or achieve substantially the same result as the corresponding embodiments described herein, may be utilized according to the present invention. Accordingly, the appended claims are intended to include within their scope such processes, machines, means, processes, and/or steps.

What is claimed is:

1. A method comprising:
a) adding a polyolefin recyclate to a reaction zone in a mixing apparatus;
b) adding an amount of specific energy to the polyolefin recyclate in the form of mechanical shearing to produce a first treated polymer recyclate;
c) reducing pressure on at least a portion of the reaction zone to less than atmospheric pressure; and
d) withdrawing a second treated polymer recyclate and an off-gas byproduct stream from the reaction zone;
wherein:
the polyolefin recyclate has a first melt index (MI₁);
the second treated polymer recyclate has a second melt index (MI₂); and
MI₂/MI₁ is greater than or equal to 3.

2. The method of claim 1, wherein:
a) the first treated polymer recyclate has a third melt index (MI₃); and
b) MI₂/MI₃ is greater than or equal to 1.10.

3. The method of claim 1, wherein the reaction zone is operated at a temperature in the range of from 300° C. to 350° C.

4. The method of claim 1, wherein the amount of specific energy is in the range of from 0.49 kW·hr/kg to 0.99 kW·hr/kg.

5. The method of claim 1, wherein:
a) the first melt index is an I₂ (ASTM D-1238, 2.16 kg, 190° C.) in the range of from 0.2 dg/min. to 2.5 dg/min., and second treated polymer recyclate has an I₂ (ASTM D-1238, 2.16 kg, 190° C.) greater than or equal to 20 dg/min.;
b) the first melt index is an I₂₁ (ASTM D-1238, 21.6 kg, 190° C.) in the range of from 5 dg/min. to 70 dg/min., and second treated polymer recyclate has an I₂₁ (ASTM D-1238, 21.6 kg, 190° C.) greater than or equal to 200 dg/min.; or
c) a combination thereof.

6. The method of claim 1, wherein:
the polyolefin recyclate has a first density (D₁);
the second treated polymer recyclate has a second density (D₂); and

|D₁−D₂| is less than or equal to 0.005 g/cm₃.

7. The method of claim 1, wherein:
the polyolefin recyclate has a first weight average molecular weight (M_{w1});
the second treated polymer recyclate has a second weight average molecular weight (M_{w2}); and
(M_{w2})/(M_{w1}) is less than or equal to 0.80.

8. The method of claim 1, wherein:
the polyolefin recyclate has a first weight average molecular weight (M_{z1});
the second treated polymer recyclate has a second weight average molecular weight (M_{z2}); and
(M_{z2})/(M_{z1}) is less than or equal to 0.60.

9. The method of claim 1, wherein:
the polyolefin recyclate has a first ratio of weight average molecular weight to number average molecular weight ((M_{w}/Mₙ)₁);
the second treated polymer recyclate has a second ratio of weight average molecular weight to number average molecular weight ((M_{w}/Mₙ)₂); and
(M_{w}/Mₙ)₂/(M_{w}/Mₙ)₁ is less than or equal to 0.80.

10. The method of claim 1, wherein:
the polyolefin recyclate has a first ratio of weight average molecular weight to number average molecular weight ((M_{z}/M_{w})₁);
the second treated polymer recyclate has a second ratio of weight average molecular weight to number average molecular weight ((M_{z}/M_{w})₂); and
(M₂/M_{w})₂/(M₂/M_{w})₁ is less than or equal to 0.90.

11. The method of claim 1, wherein the polyolefin recyclate comprises a polyethylene, a polypropylene, or a combination thereof.

12. The method of claim 1, wherein the pressure is reduced to a pressure in the range of from 7.6 mm Hg absolute to 684 mm Hg absolute.

13. The method of claim 1, wherein the reaction zone resides in an extruder and comprises 25% or more of the length of the extruder.

14. The method of claim 1, wherein a residence time in the reaction zone is in the range of from range of from 5 seconds to 5 minutes.

15. The method of claim 1, further comprising injecting an inert gas, oxygen, or a combination thereof, into the reaction zone.

16. The method of claim 1, wherein the atmosphere in the reaction zone is maintained at a nitrogen content in the range of from 60 vol % to 100 vol %, and vol % is based on the total amount of oxygen and nitrogen.

17. The method of claim 1, wherein the atmosphere in the reaction zone is maintained at an oxygen content in the range of from 0 vol % to 40 vol %, and vol % is based on the total amount of oxygen and nitrogen.

18. The method of claim 1, wherein the reaction zone resides in an extruder, and the pressure is reduced on the reaction zone at a location along the length of the extruder in the range of from 50% to 100% from a feed end of the extruder, wherein:
i) the polyolefin recyclate is added to the reaction zone proximate to the feed end of the extruder;
ii) the second treated polymer recyclate is withdrawn from the reaction zone proximate to a discharge end of the extruder;
iii) the feed end is 0%; and
iv) the discharge end is 100%.

19. The method of claim 1, wherein the reaction zone resides in an extruder, and the method further comprising injecting nitrogen into the reaction zone at a location along the length of the extruder in the range of from 0% to 50% from a feed end of the extruder, wherein:
i) the polyolefin recyclate is added to the reaction zone proximate to the feed end of the extruder;
ii) the second treated polymer recyclate is withdrawn from the reaction zone proximate to a discharge end of the extruder;
iii) the feed end is 0%; and
iv) the discharge end is 100%.

20. The method of claim 1, wherein the reaction zone resides in an extruder, and the method further comprising injecting oxygen into the reaction zone at a location along the length of the extruder in the range of from 0% to 50% from a feed end of the extruder, wherein:
i) the polyolefin recyclate is added to the reaction zone proximate to the feed end of the extruder;
ii) the second treated polymer recyclate is withdrawn from the reaction zone proximate to a discharge end of the extruder;
iii) the feed end is 0%; and
iv) the discharge end is 100%.
